(19) United States
(12) Patent Application Publication
(10) Pub. No.: US 2013/0151130 A1
(43) Pub. Date: Jun. 13, 2013

(54) IDLE REDUCTION CONTROLLER FOR ENGINE

(71) Applicant: Denso Corporation, Kariya-city (JP)

(72) Inventors: Keisuke TSUCHITA, Nagoya-city (JP); Kenji SUNAMI, Obu-city (JP); Ryouta NAKAMURA, Handa-city (JP)

(73) Assignee: DENSO CORPORATION, Kariya-city (JP)

(21) Appl. No.: 13/706,588

(22) Filed: Dec. 6, 2012

(30) Foreign Application Priority Data
Dec. 9, 2011 (JP) 2011-269935

(51) Int. Cl. F02D 41/08

(52) U.S. Cl. CPC F02D 41/08
USPC 701/112

(57) ABSTRACT

When a vehicle speed is decreased to a first deceleration threshold value which is greater than zero, an idle reduction controller executes a first engine-shut-down to automatically shut down an engine. In a monitoring period from when the vehicle speed falls below a second deceleration threshold value which is greater than the first deceleration threshold value until when the vehicle speed becomes the first deceleration threshold value, when a steering operation is conducted by a driver, the first engine-shut-down is prohibited. Then, when the vehicle speed exceeds the second deceleration threshold value, a prohibition of the first engine-shut-down is canceled.

### CROSS-REFERENCE TO RELATED APPLICATION

This application is based on Japanese Patent Application No. 2011-269935 filed on Dec. 9, 2011, the disclosure of which is incorporated herein by reference.

### TECHNICAL FIELD

The present disclosure relates to an idle reduction controller for an engine, which shuts down an engine automatically.

### BACKGROUND

JP-2002-303235A shows an engine starting device which automatically shuts down an engine when a predetermined shut-down condition is established. Then, when a predetermined start-up condition is established, the engine starting device automatically starts up the engine.

Also, JP-10-318012A describes that an engine is automatically shut down when a vehicle speed becomes lower than 2 km/h.

In a case that the vehicle is decelerated to automatically shut down the engine, when a predetermined start-up condition is established by a driver, an acceleration of the vehicle is delayed due to a time lag until the engine is restarted, whereby it is likely that a maneuverability (drivability) of the vehicle may be deteriorated. In order to avoid such a deterioration, it is conceivable that the automatic shut-sown of the engine is canceled in the above condition. However, if the automatic shut-down is simply cancelled, it is less likely that the fuel economy is improved. Thus, it is desirable that the automatic shut-sown control should be cancelled in view of a road condition, a driving condition and the like.

### SUMMARY

It is an object of the present disclosure to provide an idle reduction controller for an engine, which is able to avoid a deterioration in maneuverability of a vehicle.

According to the present disclosure, an idle reduction controller includes a first engine-shut-down portion which automatically shuts down the engine when a vehicle speed is decreased to a first deceleration threshold value which is greater than zero.

Furthermore, the idle reduction controller includes a determining portion, a prohibiting portion, and a canceling portion. The determining portion determines whether a steering operation is conducted by a driver in a period from when the vehicle speed falls below a second deceleration threshold value which is greater than the first deceleration threshold value until when the vehicle speed becomes the first deceleration threshold value.

The prohibiting portion prohibits the first engine-shut-down portion from shutting down the engine when the determining portion determines that the steering operation is conducted. That is, the prohibiting portion prohibits an execution of the first engine-shut-down. Thus, when a steering operation is conducted by a driver in a monitoring period, the engine is not automatically shut down even if the vehicle speed falls below the first deceleration threshold value.

Further, the canceling portion cancels a prohibition in which the first engine-shut-down portion is prohibited from shutting down the engine when the vehicle speed exceeds to a specified cancel-determination value while the prohibiting portion prohibits the first engine-shut-down portion from shutting down the engine.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic chart showing a configuration of an idle-reduction ECU;

FIG. 2 is a flow chart showing the idle reduction control processing; and

FIGS. 3A to 3E are time charts for explaining an operation of an idle reduction controller according to an embodiment.

### DETAILED DESCRIPTION

An embodiment of an idle reduction controller for an engine will be described hereinafter. In the following description, an electronic control unit as an idle reduction controller will be referred to as an idle-reduction ECU.

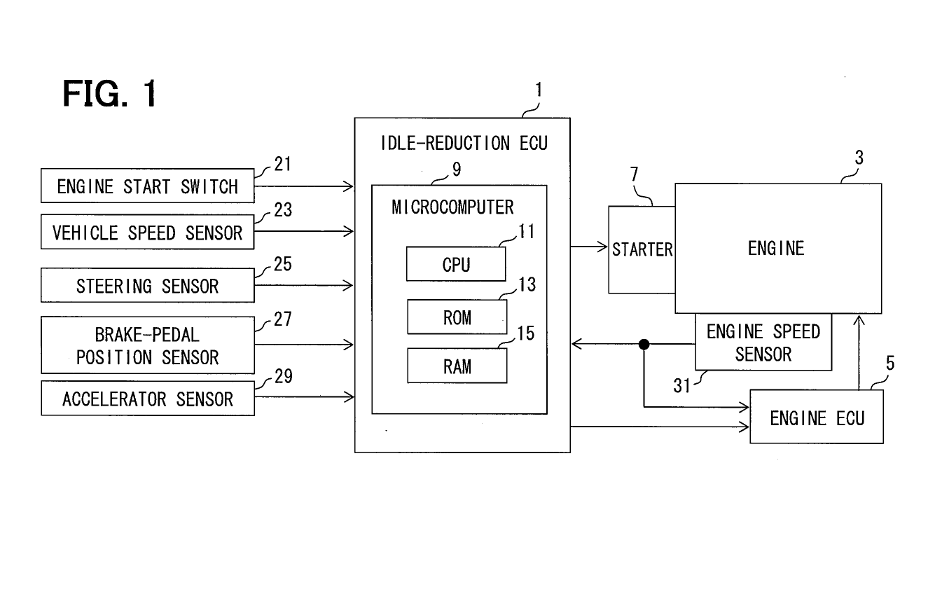

FIG. 1 is a schematic chart showing a configuration of an idle-reduction ECU 1. The idle-reduction ECU 1 is mounted to a vehicle and cooperates with an electronic control unit controlling an engine 3 in order to execute an idle reduction control in which the engine 3 is automatically shut down and a starter 7 is controlled to start up the engine 3. The electronic control unit controlling the engine 3 is referred to as an engine ECU 5, hereinafter.

The idle-reduction ECU 1 has a microcomputer 9 which executes various processing for the idle reduction control. The microcomputer 9 includes CPU 11, ROM 13, RAM 15 and an input/output interface (not shown).

Moreover, the idle-reduction ECU 1 includes an input circuit for transmitting signals into the microcomputer 9 and a driving circuit for driving the starter 7 according to a command signal from the microcomputer 9.

Information signals for performing the idle reduction control and the control of the starter 7 are transmitted to the idle-reduction ECU 1. The information signals are inputted into the microcomputer 9 through the input circuit.

For example, the information signals include a start command signal from an engine start switch 21 which a driver of a vehicle manipulates when the driver wants to start the engine 3. Further, the information signals include a vehicle speed signal from a vehicle speed sensor 23 detecting a vehicle speed, a steering signal from a steering sensor 25 detecting an operation angle of a steering wheel, a brake signal from a brake-pedal position sensor 27 detecting a stepped amount of the brake pedal, an accelerator signal from an accelerator sensor 29 detecting a stepped amount of the accelerator pedal, and an engine speed signal from an engine speed sensor 31.

The engine speed signal is inputted also into the engine ECU 5 to detect an engine speed.

A processing which the microcomputer 9 of an idle-reduction ECU 1 performs will be explained, hereinafter.

When an ignition switch is turned on, the microcomputer 9 is activated.

When the microcomputer 9 detects that the start command signal from the engine start switch 21 becomes active level (High level), the microcomputer 9 executes a starter control in which the starter 7 is driven to start up the engine 3.

Specifically, the microcomputer 9 drives the starter 7 through the driving circuit to start up the engine 3. The engine ECU 5 executes a fuel injection and an ignition to the engine 3. In a case that the engine 3 is a diesel engine, only fuel injection is performed. Then, the microcomputer 9 determines whether the engine 3 is completely started up based on the engine speed. When the microcomputer 9 determines that the engine 3 is completely started up, the starter 7 is turned off.

By performing the above processing which is referred to as a starter-control processing, the engine 3 is completely started up. After the engine 3 is completely started up, the microcomputer 9 executes an idle reduction control which will be described later. In the idle reduction control, when the microcomputer 9 determines that a condition for automatically shutting down the engine 3 is established, the microcomputer 9 executes an automatic shut-down processing control to shut down the engine 3 automatically. Specifically, the microcomputer 9 transmits an engine shut-down command to the engine ECU 5. Then, the engine ECU 5 terminates the fuel injection or an intake air supply to the engine 3 so that the engine 3 is shut down. It should be noted that an engine condition in which the engine 3 is automatically shut down by the idle-reduction ECU 1 is referred to as an idle reduction condition. A period from when the engine 3 is automatically shut down until when the engine 3 is automatically re-started up is referred to as an idle reduction period.

When the microcomputer 9 determines that the predetermined start-up condition is established in the idle reduction period, the microcomputer executes the starter-control processing to re-start the engine 3 automatically. The start-up condition is established, for example, when a brake pedal is released, an operation angle of a steering wheel becomes greater than a specified angle, or a driver conducts another operation to drive a vehicle with the brake pedal stepped.

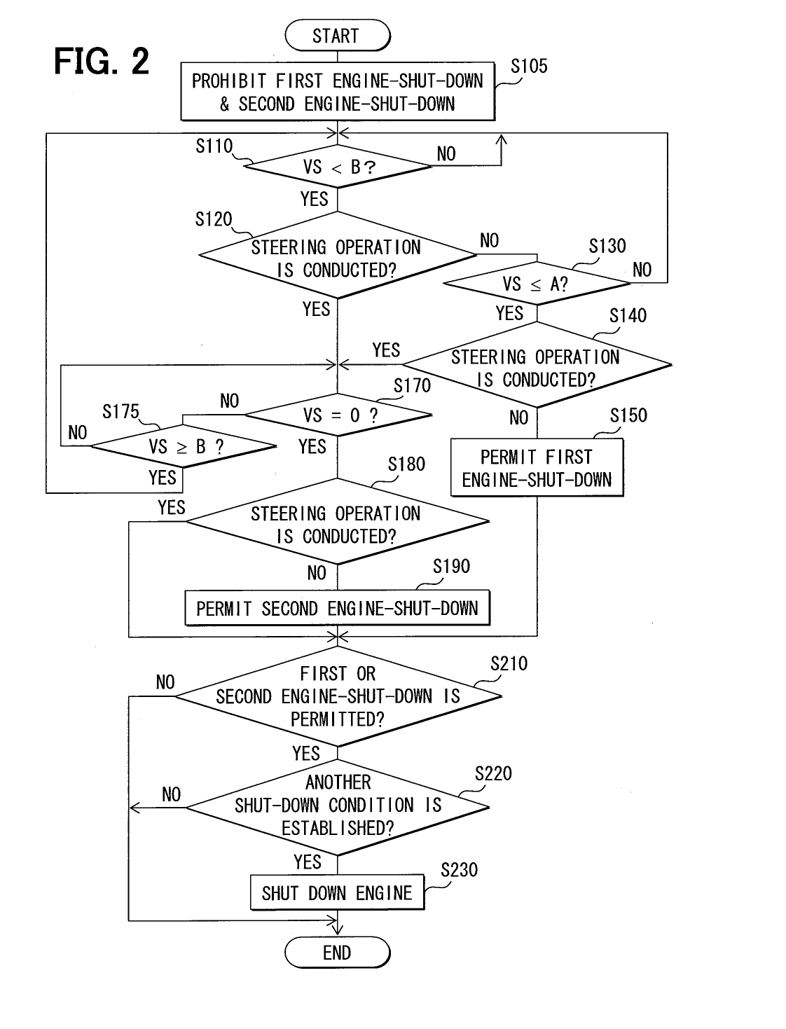

FIG. 2 is a flow chart showing the idle reduction control processing. The microcomputer 9 detects a vehicle speed for every certain time based on the speed signal from the vehicle speed sensor 23. When the microcomputer 9 determines that the engine 3 is running and the vehicle speed is greater than or equal to a second deceleration threshold value “B” (for example, 30 km/h), the microcomputer 9 starts the idle reduction control processing.

In S105, the microcomputer 9 prohibits a first engine-shut-down and a second engine-shut-down. In the first engine-shut-down, the engine 3 is automatically shut down while the vehicle is decelerated. In the second engine-shut-down, the engine 3 is automatically shut down when the vehicle is stopped.

In S110, the microcomputer 9 determines whether the vehicle speed “VS” is less than the second deceleration threshold value “B”. When the vehicle speed “VS” becomes less than the second deceleration threshold value “B”, the procedure proceeds to S120.

In S120, the microcomputer 9 determines whether a steering operation by a driver is conducted based on the steering signal from the steering sensor 25. Specifically, when the operation angle of the steering wheel is greater than or equal to a first threshold angle, the microcomputer 9 determines that the steering operation is conducted. The first threshold angle corresponds to an operation angle of the steering wheel which is generated when a vehicle changes lanes at a vehicle speed lower than the second deceleration threshold value “B”. For example, the first threshold angle is set to 20°.

When the answer is NO in S120, the procedure proceeds to S130 in which the microcomputer 9 determines whether the vehicle speed is less than or equal to a first deceleration threshold value “A” (for example, 15 km/h) which is lower than the second deceleration threshold value “B”. When the answer is NO in S130, the procedure goes back to S110.

As above, during a monitoring period from when the vehicle speed becomes lower than the second deceleration threshold value “B” until when the vehicle speed becomes the first deceleration threshold value “A”, it is determined whether a steering operation by a driver is conducted in S120.

When the answer is YES in S130, the procedure proceeds to S140 in which the microcomputer 9 determines whether a steering operation by a driver is conducted.

It should be noted that the microcomputer 9 determines that the steering operation is conducted when the operation angle of the steering wheel is greater than or equal to a second threshold angle, in S140. The second threshold angle is established for determining whether the engine 3 should be shut down when the vehicle speed falls to the first deceleration threshold value “A”. The second threshold angle may be equal to or different from the first threshold angle.

When the answer is NO in S140, the procedure proceeds to S150 in which the first engine-shut-down is permitted. Then, the procedure proceeds to S210. When the answer is YES in S140, the procedure proceeds to S170.

Also, when the answer is YES in S120, the procedure proceeds to S170.

In S170, the microcomputer 9 determines whether the vehicle speed is zero. When the answer is NO, the procedure proceeds to S175 in which the microcomputer 9 determines whether the vehicle speed is greater than or equal to a cancel-determination value. In the present embodiment, the cancel-determination value is established equal to the second deceleration threshold value “B”. When the answer is NO in S175, the procedure goes back to S170.

When the answer is YES in S170, the procedure proceeds to S180 in which the microcomputer 9 determines whether the steering operation is conducted.

It should be noted that the microcomputer 9 determines that the steering operation is conducted when the operation angle of the steering wheel is greater than or equal to a third threshold angle, in S180. The third threshold angle is established for determining whether the second engine-shut-down may be permitted. The third threshold angle may be equal to or different from the first or the second threshold angle.

When the answer is NO in S180, the procedure proceeds to S190 in which the second engine-shut-down is permitted. Then, the procedure proceeds to S210. When the answer is YES in S180, the procedure proceeds to S210.

In S210, the microcomputer 9 determines whether the first engine-shut-down or the second engine-shut-down is permitted in S150 or S190. When the answer is YES in S210, the procedure proceeds to S220 in which the microcomputer 9 determines whether another shut-down condition is established for automatically shutting down the engine 3.

Another shut-down condition is established when the brake pedal is stepped, an accelerator pedal is not stepped and a charging rate of a battery is greater than a specified value, for example.

When the answer is YES in S220, the procedure proceeds to S230 in which the above automatic shut-down processing is executed to automatically shut down the engine 3. Then, the idle reduction control processing is terminated.

When the answer is NO in S210 or S220, the procedure ends without conducting the idle reduction control.

When the answer is YES in S175, the procedure goes back to S110. Thus, when the vehicle speed increases and exceeds the second deceleration threshold value “B”, the processes in S130 to S150 can be conducted.

As a modification, when the answer is YES in S180, the procedure may go back to S170. When the first threshold angle is equal to the second threshold angle and the answer is YES in S130, the procedure may proceed from S130 to S150. That is, when the answer is NO in S120 and the answer is YES in S130, it is less likely that the answer is YES in S140.

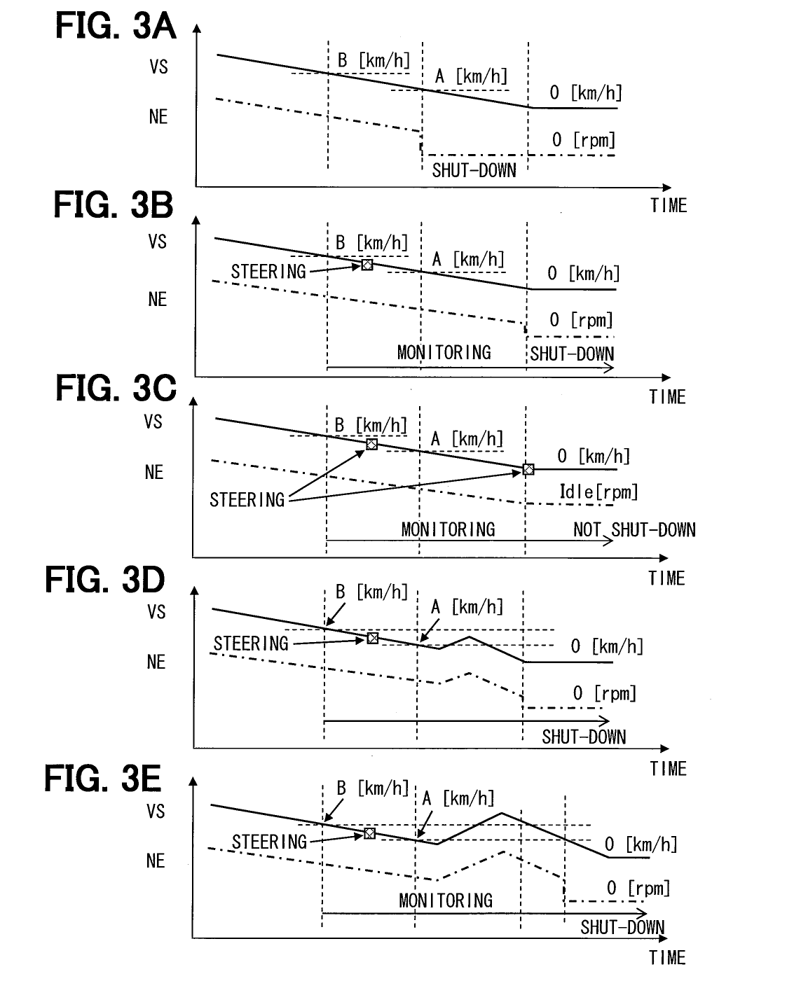

Referring to FIGS. 3A to 3E, an operation of the idle-reduction ECU 1 will be explained, hereinafter.

As shown in FIG. 3A, in a period from when the vehicle speed “VS” falls below the second deceleration threshold value “B” (S110: YES) until when the vehicle speed “VS” becomes the first deceleration threshold value “A”, if no steering operation is conducted (S120: NO), the first engine-shut-down is permitted (S150) at a time when the vehicle speed “VS” reaches the first deceleration threshold value “A” (S150). Further, when another shut-down condition is established, the engine 3 is automatically shut down (S230). Finally, the engine speed “NE” becomes zero.

Meanwhile, as shown in FIG. 3B, in a period from when the vehicle speed “VS” falls below the second deceleration threshold value “B” until when the vehicle speed “VS” becomes the first deceleration threshold value “A”, if a steering operation is conducted (S120: YES), the idle-reduction ECU 1 prohibits the execution of procedure in S130 to S150. Such a condition is referred to as a first engine-shut-down prohibiting state. Even if the vehicle speed “VS” falls below the first deceleration threshold value “A”, the engine 3 is not shut down. That is, it is prohibited to execute the first engine-shut-down.

At a time when the vehicle speed “VS” becomes zero (S170: YES), if no steering operation is conducted (S180: NO), the second engine-shut-down is permitted (S190). If another shut-down condition is established, the engine 3 is automatically shut down (S230). That is, the second engine-shut-down is conducted.

Meanwhile, as shown in FIG. 3C, at a time when the vehicle speed “VS” becomes zero (S170: YES), if a steering operation is conducted (S180: YES), the second engine-shut-down is not be permitted. Thus, the engine 3 is not shut down but at idling state. In FIG. 3C, “Idle” represents an idle speed of the engine 3.

Also, as shown in FIG. 3D, in a period from when the vehicle speed “VS” falls below the second deceleration threshold value “B” until when the vehicle speed “VS” becomes the first deceleration threshold value “A”, even when the idle-reduction ECU 1 is brought into the first engine-shut-down prohibiting state (S120: YES) and the vehicle is re-accelerated, the first engine-shut-down prohibiting state is continued unless the vehicle speed “VS” becomes greater than or equal to the second deceleration threshold value “B” (S175: NO).

FIG. 3D shows a case in which no steering operation is conducted at a time when the vehicle speed becomes zero and the second engine-shut-down is conducted to automatically shut down the engine 3. If a steering operation is conducted at a time when the vehicle speed becomes zero, the engine 3 is not shut down but brought into the idling state.

Meanwhile, as shown in FIG. 3E, in a period from when the vehicle speed “VS” falls below the second deceleration threshold value “B” until when the vehicle speed “VS” becomes the first deceleration threshold value “A”, when the idle-reduction ECU 1 is brought into the first engine-shut-down prohibiting state (S120: YES) and the vehicle is re-accelerated so that the vehicle speed “VS” greater than or equal to the second deceleration threshold value “B” (S175: YES), the first engine-shut-down prohibiting state is canceled. That is, the idle-reduction ECU 1 can executes the processings in S130 to S150.

As shown in FIG. 3E, after the vehicle speed “VS” becomes greater than the second deceleration threshold value “B”, in a period from when the vehicle speed “VS” decreases to the second deceleration threshold value “B” again until when the vehicle speed becomes the first deceleration threshold value “A”, if no steering operation is conducted by a driver, the first engine-shut-down is permitted at a time when the vehicle speed becomes the first deceleration threshold value “A”. Further, when another shut-down condition is established, the engine 3 is automatically shut down.

It should be noted that a period in which the vehicle speed “VS” is less than the second deceleration threshold value “B” corresponds to a steering monitoring period during which it is monitored whether a steering operation is conducted for the idle reduction control.

In the monitoring period during which the vehicle speed “VS” is greater than the first deceleration threshold value “A” and is lower than the second deceleration threshold value “B”, when the steering operation by a driver is detected, it is likely that the vehicle is making a lane change with deceleration (S120: YES). It is determined that the vehicle is just before going into a crossing or immediately after going into a crossing. The idle-reduction ECU 1 prohibits the first engine-shut-down.

Therefore, when the vehicle is going into a crossing to turn right or left, the first engine-shut-down is no longer conducted, whereby it is avoided that an acceleration of the vehicle is delayed at the crossing. Therefore, it is restricted that a maneuverability of the vehicle is deteriorated at the crossing.

Furthermore, when the vehicle is in the first engine-shut-down prohibiting state and the vehicle speed becomes greater than the second deceleration threshold value “B”, the idle-reduction ECU 1 cancels the first engine-shut-down prohibiting state (S175: YES). When the vehicle is making only a lane change with deceleration not to turn right or left at a crossing and the vehicle speed becomes greater than the second deceleration threshold value “B”, the first engine-shut-down can be conducted.

Meanwhile, in the first engine-shut-down prohibiting state, unless the vehicle speed “VS” becomes greater than or equal to the second deceleration threshold value “B”, the first engine-shut-down prohibiting state can be maintained. In a case that an exclusive lane for turning right or left is defined before a crossing on a road, it is likely that a vehicle is slightly accelerated after the vehicle runs into the exclusive lane with deceleration to turn right or left at the crossing. Even in such a case, if the vehicle speed “VS” does not exceeds the second deceleration threshold value “B”, the first engine-shut-down prohibiting state can be maintained. Thus, it can be avoided that the first engine-shut-down prohibiting state is canceled when the vehicle is before a crossing or in a crossing.

Moreover, even though the idle-reduction ECU 1 detects no steering operation by a driver in the monitoring period, when it is determined that a steering operation is conducted in S140 at a time when the vehicle speed is the first deceleration threshold value “A”, the first engine-shut-down will not be conducted. Thus, it can be avoided that the engine 3 is automatically shut down when a vehicle turns right or left at a crossing.

Also, even in the first engine-shut-down prohibiting state, if no steering operation is conducted by a driver at a time when the vehicle is stopped, the second engine-shut-down is permitted in S190 to automatically shut down the engine 3. Thus, even in the first engine-shut-down prohibiting state, if the driver stops the vehicle traveling in a straight line, the idle reduction is automatically conducted to improve the fuel economy.

It should be noted that the cancel-determination value in S175 is not always equal to the second deceleration threshold value “B”. The cancel-determination value is greater than the first deceleration threshold value “A” and is preferably greater than or equal to the second deceleration threshold value “B”. Also, the cancel-determination value may be a variable value. In this case, when the answer is YES in S120, a vehicle speed is detected. A specified value is added to the detected vehicle speed to establish the cancel-determination value.

The processes in S130 to S150 and S210 to S230 correspond to processes which a first engine-shut-down executes. The processes in S110, S120 and S130 correspond to processes which a determining portion executes. When the answer is YES in S120, the procedure proceeds to S170. This procedure corresponds to processes which a prohibiting portion executes. When the answer is YES in S175, the procedure goes back to S110. This procedure corresponds to processes which a canceling portion executes. The processes in S170 and S180 to S230 correspond to processes which a second engine-shut-down portion executes.

One of the preferred embodiments is described above. The present disclosure is not limited to the above embodiment.

For example, in a case of left-hand traffic, it may be determined, in S120, whether a steering operation is conducted so that a vehicle turns right. In a case of right-hand traffic, it may be determined whether a steering operation is conducted so that a vehicle turns left. Specifically, it is determined whether an operation angle of the steering from a center position is greater than a specified threshold.

What is claimed is:

1. An idle reduction controller for an engine, comprising:
a first engine-shut-down portion for automatically shutting down the engine when a vehicle speed is decreased to a first deceleration threshold value which is greater than zero;
a determining portion for determining whether a steering operation is conducted by a driver in a period from when the vehicle speed falls below a second deceleration threshold value which is greater than the first deceleration threshold value until when the vehicle speed becomes the first deceleration threshold value;
a prohibiting portion for prohibiting the first engine-shut-down portion from shutting down the engine when the determining portion determines that the steering operation is conducted; and
a canceling portion for canceling a prohibition in which the first engine-shut-down portion is prohibited from shutting down the engine when the vehicle speed exceeds to a specified cancel-determination value while the prohibiting portion prohibits the first engine-shut-down portion from shutting down the engine.

2. An idle reduction controller for an engine according to claim 1, wherein
the cancel-determination value is greater than or equal to the second deceleration threshold value.

3. An idle reduction controller for an engine according to claim 1, wherein
the first engine-shut-down portion automatically shuts down the engine when the vehicle speed is decreased to the first deceleration threshold value and no steering operation is conducted.

4. An idle reduction controller for an engine according to claim 1, further comprising:
a second engine-shut-down portion for automatically shutting down the engine when the vehicle speed becomes zero and no steering operation is conducted even though the prohibiting portion prohibits the first engine-shut-down portion from shutting down the engine.
